(19) United States
(12) Patent Application Publication
(10) Pub. No.: US 2007/0174074 A1
(43) Pub. Date: Jul. 26, 2007

(54) Method, system, and program product for detecting behavior change in transactional data

(75) Inventors: Mark S. Ramsey, Kihei, HI (US); David A. Selby, Nr Fareham (GB); Stephen J. Todd, Winchester (GB)

Correspondence Address: HOFFMAN, WARNICK & D'ALESSANDRO LLC, 75 STATE ST, 14TH FLOOR, ALBANY, NY, 12207, US

(73) Assignee: International Business Machine Corporation, Armonk, NY (US)

(21) Appl. No.: 11/338,240

(22) Filed: Jan. 24, 2006

(51) Int. Cl. G06Q 99/00; G07G 1/00; G06F 17/30

(52) U.S. Cl. 705/1; 705/10

(57) ABSTRACT

A computer-implemented method, system, and program product for accumulating and analyzing transactional data to detect a behavior change, which may be due to customer dissatisfaction. Specifically, under the present invention, a transactional data value is provided that reflects a measurement of transactions that have occurred in a particular time period. This transactional data value is then incorporated into a running mean and a running square and running standard deviation are computed therefrom. A variance of the transactional data value in terms of the standard deviation is then compared against a threshold to determine whether the transactional data value indicates a change in entity behavior. This allows the determination to be made without the need to store multiple transactional data values. Once a determination has been made that an entity's behavior was changed, the determination may be verified using a transactional data value over a second time period, and/or a communication may be sent to the entity.

### FIELD OF THE INVENTION

The present invention generally relates to data analysis. Specifically, the present invention provides a tool for analyzing transactional data and projecting behavior change therefrom.

### BACKGROUND OF THE INVENTION

In the business world of today companies are always looking for new ways to keep and/or expand their markets for their goods and services. One concept that is important to accomplishing this goal is that of repeat business. Companies go to great lengths to ensure that all or a majority of their best customers are satisfied with the goods and services provided them. Customers that are satisfied normally seek to do business with the company again if the same or similar goods and services are needed, while those who are unsatisfied will often seek a different company with which to do business.

One industry for which repeat business is particularly important is the travel industry, especially business travel. Business travelers travel more frequently and constitute the majority of income for travel related business such as airlines, hotels, automobile rentals, etc. To this extent, it is very important for a travel related business to maintain satisfaction among its important business travelers.

One of the challenges of maintaining customer satisfaction is that there is currently no effective way of determining whether an important business customer has become dissatisfied. One reason for this is that when an event occurs that causes a client to become dissatisfied, most often the client will simply change business providers without informing the former provider of its decision. As such, the dissatisfied client may have already begun to forge a business relationship with a competitor before the former provider even knows that the client has left.

Currently, there are few ways to combat the problem of customer attrition, and even these ways are often inefficient. One way that a business may try to monitor customer satisfaction is to distribute a survey to its customers. This survey may be sent out periodically to a select number of customers or may be provided to all customers in conjunction with the good or service. However, surveys are time consuming to fill out and, as such, many customers, particularly busy customers such as business travelers, will simply ignore them. Furthermore, blanket surveys provided at the time of service are provided to everyone without distinguishing between preferred customers, such as business travelers, and normal customers and between those customers that are satisfied and those that are unsatisfied. Still further, although periodical surveys may be targeted to a particular group of customers, such as business travelers, the timing of the survey may not coincide with a customer becoming unsatisfied and may therefore not be useful for forecasting and/or correcting customer dissatisfaction.

In view of the foregoing there exists a need for a tool that overcomes the above-referenced deficiencies.

### SUMMARY OF THE INVENTION

In general, the present invention provides a computer-implemented method, system, and program product for accumulating and analyzing transactional data to detect a behavior change, which may be due to customer dissatisfaction. Specifically, under the present invention, a transactional data value is provided that reflects a measurement of transactions that have occurred in a particular time period. This transactional data value is then incorporated into a running mean and a running square and running standard deviation are computed therefrom. A variance of the transactional data value in terms of the standard deviation is then compared against a threshold to determine whether the transactional data value indicates a change in entity behavior. The use of a running mean, a running square and/or running standard deviation allows the determination to be made without the need to store multiple transactional data values. Once a determination has been made that an entity's behavior was changed, the determination may be verified using a transactional data value over a second time period, and/or a communication may be sent to the entity.

A first aspect of the present invention provides a method for accumulating and analyzing transactional data to detect a behavior change, comprising: providing a transactional data value based on a number of transactions of a customer over a current time period; computing, using the transactional data value, a running mean value; computing, using the running mean value, a running mean square value; computing, using the running mean square value, a running standard deviation; and determining, using the running standard deviation, whether the transactional data value constitutes a behavior change for the customer, wherein the method is adapted to function without a need to store multiple transactional data values.

A second aspect of the present invention provides a system for accumulating and analyzing transactional data to detect a behavior change, comprising: a transaction data value provider for providing a transactional data value based on a number of transactions of a customer over a current time period; a running mean value computer for computing, using the transactional data value, a running mean value; a running mean square value computer for computing, using the running mean value, a running mean square value; a running standard deviation computer for computing, using the running mean square value, a running standard deviation; and a behavior change determinator for determining, using the running standard deviation, whether the transactional data value constitutes a behavior change for the customer, wherein the system is adapted to function without a need to store multiple transactional data values.

A third aspect of the present invention provides a program product stored on a computer readable medium for accumulating and analyzing transactional data to detect a behavior change, comprising, the computer readable medium comprising program code for causing a computer system to perform the following steps: provide a transactional data value based on a number of transactions of a customer over a current time period; compute, using the transactional data value, a running mean value; compute, using the running mean value, a running mean square value; compute, using the running mean square value, a running standard deviation; and determine, using the running standard deviation, whether the transactional data value constitutes a behavior change for the customer, wherein the program product is adapted to function without a need to store multiple transactional data values.

A fourth aspect of the present invention provides a method for accumulating and analyzing transactional data to detect a behavior change, comprising: providing a computer infrastructure being operable to: provide a transactional data value based on a number of transactions of a customer over a current time period; compute, using the transactional data value, a running mean value; compute, using the running mean value, a running mean square value; compute, using the running mean square value, a running standard deviation; and determine, using the running standard deviation, whether the transactional data value constitutes a behavior change for the customer, wherein the program product is adapted to function without a need to store multiple transactional data values.

A fifth aspect of the present invention provides computer software embodied in a propagated signal for accumulating and analyzing transactional data to detect a behavior change, the computer software comprising instructions for causing a computer system to perform the following steps: provide a transactional data value based on a number of transactions of a customer over a current time period; compute, using the transactional data value, a running mean value; compute, using the running mean value, a running mean square value; compute, using the running mean square value, a running standard deviation; and determine, using the running standard deviation, whether the transactional data value constitutes a behavior change for the customer, wherein the program product is adapted to function without a need to store multiple transactional data values.

Therefore, the present invention provides a method, tool, and program product for accumulating and analyzing transactional data to detect a behavior change.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative computer system having a system for accumulating and analyzing transactional data to detect a behavior change according to the present invention.

FIG. 2 shows an illustrative system for accumulating and analyzing transactional data to detect a behavior change.

FIG. 3 shows illustrative transactional data values according to the present invention.

FIG. 4 shows an illustrative standard deviation according to the present invention.

FIG. 5 shows an illustrative method flow diagram according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### BEST MODE FOR CARRYING OUT THE INVENTION

As indicated above, the present invention provides a computer-implemented method, system, and program product for accumulating and analyzing transactional data to detect a behavior change, which may be due to customer dissatisfaction. Specifically, under the present invention, a transactional data value is provided that reflects a measurement of transactions that have occurred in a particular time period. This transactional data value is then incorporated into a running mean and a running square and running standard deviation are computed therefrom. A variance of the transactional data value in terms of the standard deviation is then compared against a threshold to determine whether the transactional data value indicates a change in entity behavior. The use of a running mean, a running square and/or running standard deviation allows the determination to be made without the need to store multiple transactional data values. Once a determination has been made that an entity's behavior was changed, the determination may be verified using a transactional data value over a second time period, and/or a communication may be sent to the entity.

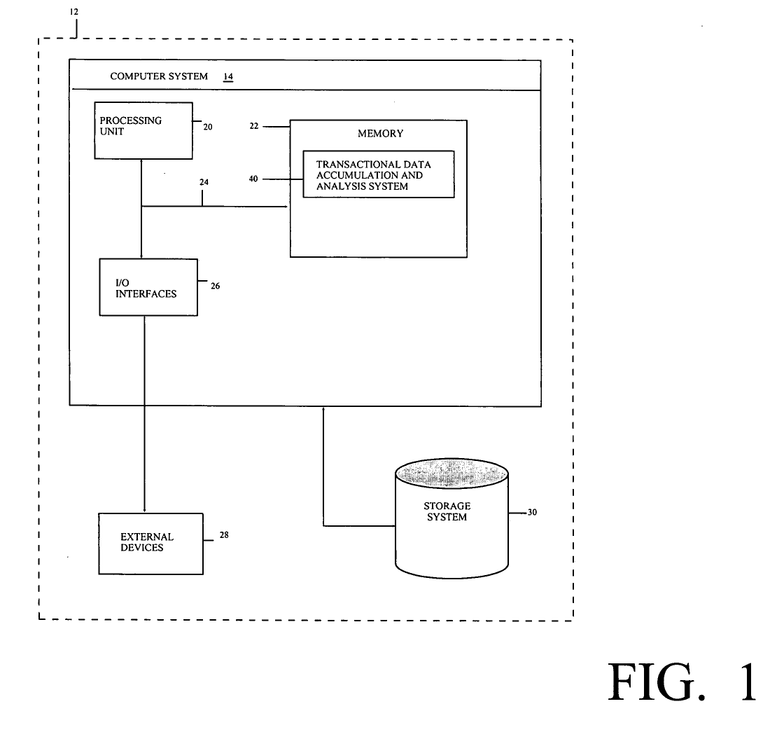

Referring now to FIG. 1, a system 10 for accumulating and analyzing transactional data to detect a behavior change according to the present invention is shown. Specifically, FIG. 1 depicts a system 10 for accumulating transactional data without having to store each data point. System 10 also analyzes the accumulated transactional data to determine whether the transactional data indicates that an entity has changed its behavior with regard to the transaction being monitored. In addition, system 10 allows an entity for which the transactional data indicates that a behavior change has occurred to be contacted in an attempt to minimize customer attrition and encourage repeat business. As depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to store a document for use in an enterprise software environment.

As shown, computer system 14 includes a processing unit 20, a memory 22, a bus 24, and input/output (I/O) interfaces 26. Further, computer system 14 is shown in communication with external I/0 devices/resources 28 and storage system 30. In general, processing unit 20 executes computer program code, such as a transactional data accumulation and analysis system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, a time period for measuring transactional data, a transactional data value, a running mean value, a running mean square value, a running standard deviation, etc. Furthermore, even it is unnecessary for the purposes of this invention to store multiple transactional data values, these transactional data values may, nevertheless, be stored in storage system 30. Still further, storage system 30 may be used to store entity information, such as a name and information for communicating with the entity, such as an address, email and/or telephone number. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is transactional data accumulation and analysis system 40, which is a software program that will provide the functions of the present invention. Transactional data accumulation and analysis system 40 provides a system for accumulating and analyzing transactional data to detect a behavior change.

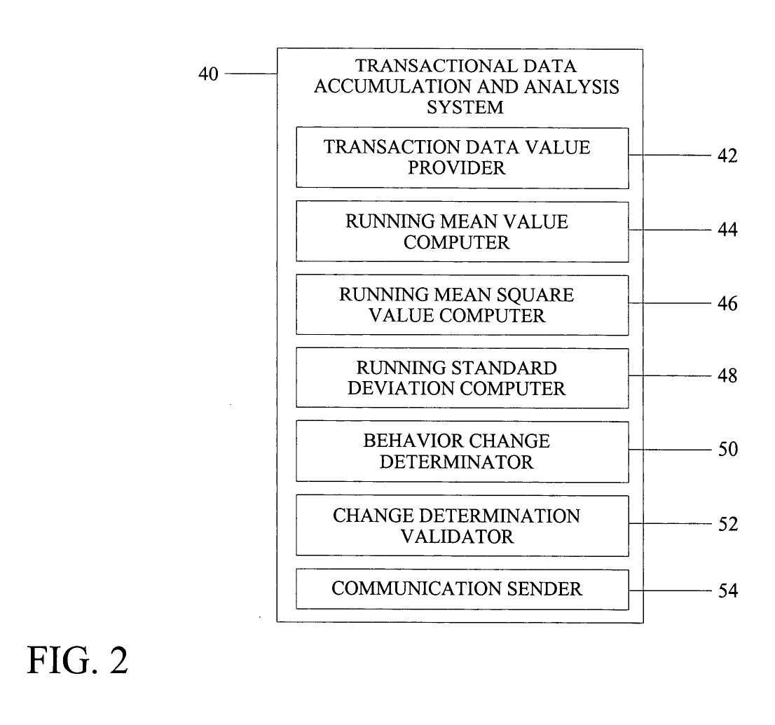

Turning now to FIG. 2, transactional data accumulation and analysis system 40 is shown in greater detail. As depicted, transactional data accumulation and analysis system 40 generally includes a transaction data value provider 42, a running mean value computer 44, a running mean square value computer 46, an a running standard deviation computer 48, a behavior change determinator 50, and, optionally, a change determination validator 52 and/or a communication sender.

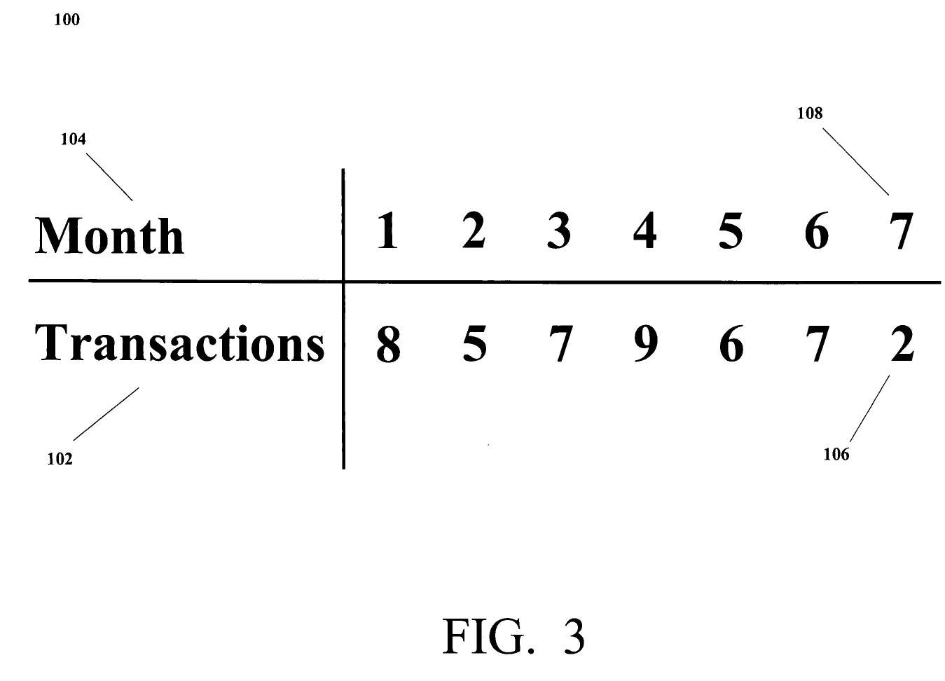

Referring now to FIGS. 2 and 3, collectively, transaction data value provider 42 provides a transactional data value 106 based on a measurement of transactions of an entity over a current time period 108. To this extent, transactional data value 106 may reflect a number of transactions that have occurred over the current time period, or, alternatively, may reflect another unit of measurement, such as total value of transactions, etc. For example, FIG. 3 shows a chart 100 having a number of transactional data values under a transactions heading 102 based on a time period 104 of monthly. Time period 104 for the transactional data values may be secondly, minutely, hourly, daily, weekly, bi-weekly, semi-monthly, monthly, bimonthly, quarterly, semi-annually, annually, or any other shorter, longer or intermediate desired time period. A transactional data value, such as transactional data value 106 is provided for current time 108. Transactional data value 106 normally reflects the number of transactions that have occurred for a particular entity over the time period. The entity may be a customer such as, for example, a business traveler or any other customer with whom a transaction is carried out. In this case, transactional data value 106 may reflect travel information such as number of flights taken, number of hotel stays and/or number of automobile rentals over the time period or any other transaction, such as a purchase of goods and/or services. In the alternative, the entity may be a computer system such as computer system 14 (FIG. 1). In this instance, transactional data value 106 may reflect an event of computer system 14, such as the depth of a queue, the time taken to process a transaction of a given type, etc. In any case, transactional data value 106 may be provided via user input, retrieved from memory 22 and/or system storage 30 (FIG. 1) or in any other manner now known or later invented for retrieving a data value. FIG. 3 shows a plurality of data values for illustrative purposes only, even though, as will be shown, only a single transactional data value need be provided.

Referring again to FIG. 2, running mean value computer 44 uses the retrieved transactional data value to compute a running mean value. In doing so, running mean value computer 44 may use the well known technique of exponential smoothing to combine the retrieved transactional data value with a previous running mean value that has been computed using previously provided transactional data values. The previous running mean value may be retrieved, such as from storage system 40, for use in the computation. The technique of using a previously computed running mean in computing a current running mean eliminates the need for storing and processing of all of the previous transactional data values for each computation of the running mean value.

Specifically, running mean value computer 46 may compute the running mean value using the following equation:
RV=(1−K)*v+K*RV_{Prev}.
In other words, the previous running mean value RVₚᵣₑᵥ is multiplied by a percentage weighting factor K to get a weighted previous running mean. Values for percentage weighting factor K are well known to those knowledgeable in the art of exponential smoothing and normally reflect a percentage value that is based on the time period, for example, 60%. The transactional data value v is also multiplied by a second percentage weighting factor (1−K) to get a weighted transactional data value. As shown above, the second percentage weighting factor is one minus the percentage weighting factor, so for example, if the percentage weighting factor is 60% then the second percentage weighting factor is 40%. Then, the weighted previous running mean is added to the weighted transactional data value to get the running mean value. Although one example of computing a running mean is shown, it should be obvious to one skilled in the art that running mean value computer 44 may use any formula that is now known or later discovered may be used to compute the running mean value.

It will be appreciated that running mean value computer 44 may use other mechanisms for computing the running mean value. For example, a predetermined number of transactional data values and/or predetermined time period may be stored, such as in storage system 30, for use in computing the running mean value. These alternatives require keeping and accessing more data for running mean value computer 44 to compute the running mean value than the use of the previous running mean value alone. However, use of such a running mean over a predetermined number of transactional data values and/or predetermined time period may give a more precise time over which the running mean is computed. In contrast, computing of the running mean value using exponential smoothing, as illustrated in the above equation, will include a small component of transactional data values that may be attributable to very distant history, depending of the value of the percentage weighting factor K. As such, the running mean value computed using exponential smoothing may not be a computation of a mean over a particular time period, e.g., six months, in the strict sense, as a portion of the data may be from outside the time period.

Running mean square value computer 46 uses the retrieved transactional data value to compute a running mean square value. In doing so, running mean square value computer 46 may use the following equation:
RVV=(1−K)*v*v+K*RVV_{Prev}.
In other words, the previous running square value is multiplied by the percentage weighting factor to get a weighted previous running mean square. Likewise, a square of the transactional data value is multiplied by the second percentage weighting factor to get a weighted transactional square value. Then, the weighted previous running square is added with the weighted transactional square value to get the running mean square value. As with the computation of the running mean value, it should be obvious to one skilled in the art that running mean square value computer 46 may use any formula that is now known or later discovered may be used to compute the running mean square value.

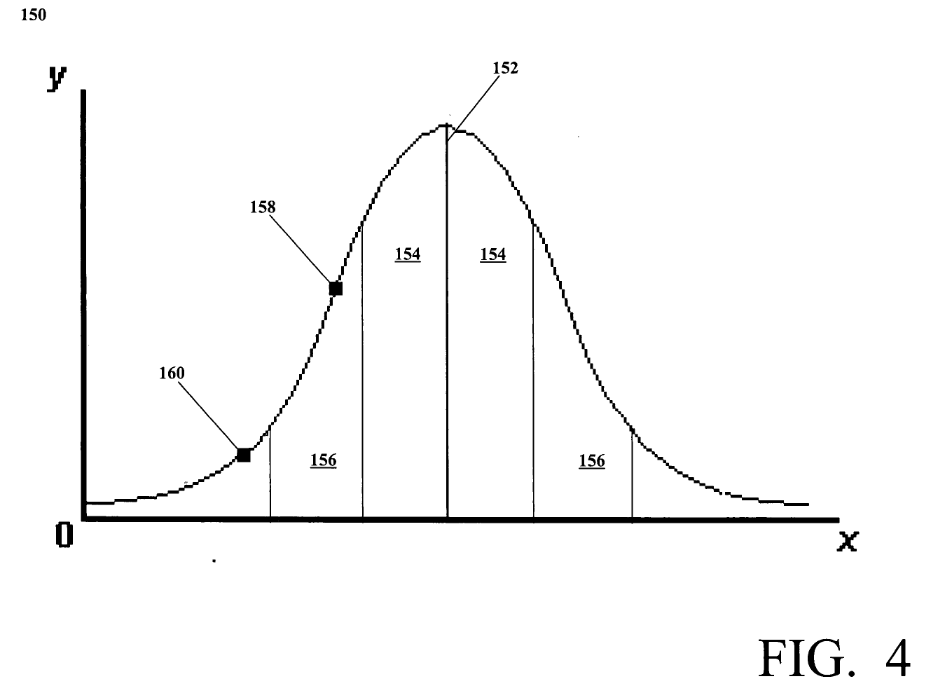

Returning now to FIGS. 2 and 4, collectively, running standard deviation computer 48 of transactional data accumulation and analysis system 40 uses the running mean square value to compute a running standard deviation. FIG. 4 shows a typical standard deviation curve 150. As shown, standard deviation curve includes a mean value 152, which in the present invention is the running mean square value computed by running mean square value computer 46. Standard deviation curve 150 also includes a first deviation 154 and a second deviation 156. Standard deviation curve 156 also includes a number of data points 158, 160, which may reflect possible transaction data values of the present invention.

Running standard deviation computer 48 may compute the running standard deviation using the following equation:
RSD=sqrt(RVV−RV*RV).
In other words, the square of the previously calculated the running mean value is subtracted from the running mean square value to get a difference. The running standard deviation is then the square root of the difference.

Behavior change determinator 50 uses the running standard deviation computed by running standard deviation computer 48 to determine whether the transactional data value constitutes a behavior change for the entity. In doing so, running mean square value computer 46 may use the following equation:
VAR−(v−RV)/(RSD).
In other words, behavior change determinator 50 may compute the difference between the transactional data value and the running mean value and divide the difference by the running standard deviation to get a variance value, such as those illustrated by data points 158 and 160. Behavior change determinator may then compare the variance value with a threshold. For example, if the threshold is defined as being outside second deviation 156 then data point 158 would be considered normal while data point 160 would indicate that a behavior change has occurred. It will be appreciated to one skilled in the art that similar calculations of the variance value and the running standard deviation may be able to avoid the need for the use of the square root function. While, these calculations may not give precisely the same answers, they should give reliable indications. However, it should be understood that the use of the square root function is illustrated here in an attempt to maintain mathematical simplicity without significantly degrading system performance.

Change determination validator 52 may optionally validate a determination by behavior change determinator 50 that the transaction data constitutes a behavior change for the entity. The validation provided by change determination validator 52 helps to prevent an overreaction from occurring from a single anomalous transaction data value. In performing this validation, determination validator 52 may use second current time period. For example, supposing the initial determination was based on a monthly time period, change determination validator may use a shorter time period, such as weekly, or a longer time period, such as quarterly. Transaction data value provider 42 provides a second transactional data value based on a second number of transactions of the entity over a second current time period. The second transactional data value is used by running mean value computer 44 to compute a second running mean value. Behavior change determinator 50 may then use the previously computed running standard deviation to determine whether the second transactional data value also constitutes a behavior change for the entity. Behavior change validator 52 may also be used in this manner to detect a trend in the variance values 158, 160 (FIG. 4) from two consecutive transactional data values. Furthermore, behavior change validator 52 may perform its own exponential smoothing in an attempt to prevent overreaction.

Communication sender 54 of transactional data accumulation and analysis system 40 sends, based on a positive determination of the behavior change for the entity from behavior change determinator 50, a communication to the entity. Communication sender 54 may send the communication via regular mail, email, facsimile, telephone, or in any other manner of communicating with an entity. Furthermore, the communication sent by communication sender 54 may include a survey, a discount notification such as a coupon, and/or a thank you letter. As indicated previously, entity information for sending the communication may be retrieved from storage system 30. In the alternative, the entity information may be provided via user input or in any other manner.

Furthermore, communication sender 54 may save an indication that a communication has been sent. This indication may be used to in conjunction with future calculations of transaction data accumulation and analysis system 40 to determine the effectiveness of the communication. For example, if a communication is sent in response to an indication of an entity behavior change, later transactional data values that indicate that the behavior of the entity returned to previous values could provide an indication that the communication was successful. In the alternative, if the transactional data remained in a behavior change mode, an inference could be made that the communication was ineffective and should be changed.

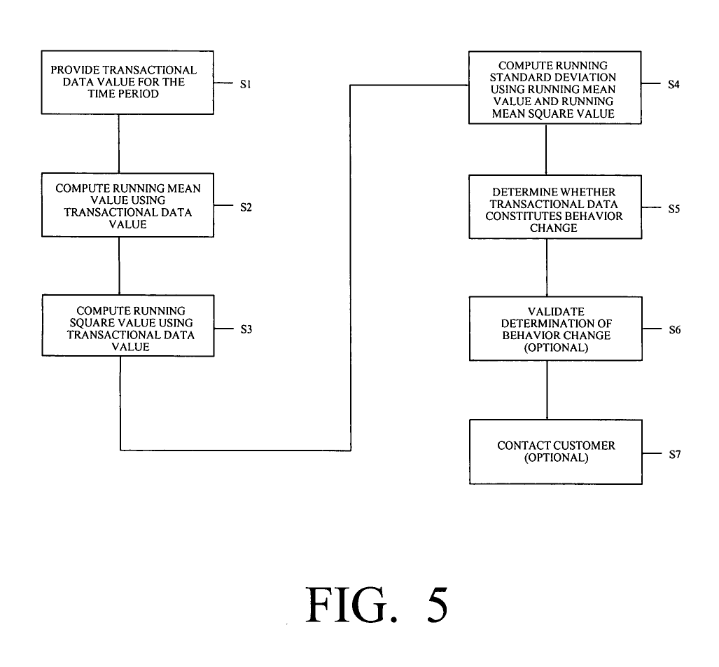

Turning now to FIG. 5, a flow chart of a method according to an embodiment of the present invention is depicted. FIG. 5 will be described with reference to FIGS. 1 and 2. In first step S1, transaction data value provider 42 provides a transactional data value based on a number of transactions of an entity over a current time period. In step S2, running mean value computer 44 computes, using the transactional data value, a running mean value. As indicated above, the computation of the running mean value may be made without a need to have multiple transactional data values stored. In step S3, running mean square value computer 46 computes, using the running mean value, a running mean square value, such as by use of the formula indicated above. In step S4, running standard deviation computer 48 computes, using the running mean square value, a running standard deviation, such as by use of the formula described above. In step S5, behavior change determinator 50 determines, using the running standard deviation, whether the transactional data value constitutes a behavior change for the entity. In optional step S6 change determination validator validates a determination that the transaction data constitutes a behavior change for the entity. Finally, in optional step S7 communication sender 54 sends a communication to the entity that is based on a positive determination of the behavior change for the entity.

While shown and described herein as a method and system for accumulating and analyzing transactional data to detect a behavior change, it is understood that the invention further provides various alternative embodiments. For example, in one embodiment, the invention provides a computer-readable/useable medium that includes computer program code to enable a computer infrastructure to accumulate and analyze transactional data to detect a behavior change. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer an accumulation and analyzing of transactional data to detect a behavior change service. In this case, the service provider can create, maintain, support, etc., a computer infrastructure, such as computer infrastructure 12 (FIG. 1) that performs the process steps of the invention for one or more entities. In return, the service provider can receive payment from the entity(s) under a subscription and/or fee agreement and/or the service provider can receive payment from the sale of advertising content to one or more third parties.

In still another embodiment, the invention provides a computer-implemented method for accumulating and analyzing transactional data to detect a behavior change. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for accumulating and analyzing transactional data to detect a behavior change, comprising:
providing a transactional data value based measurement of transactions of an entity over a current time period;
computing, using the transactional data value, a running mean value;
computing, using the transactional data value, a running mean square value;
computing, using the running mean value and running mean square value, a running standard deviation; and
determining, using the running standard deviation, whether the transactional data value constitutes a behavior change for the entity.

2. The method of claim 1, wherein the step of computing the running mean value uses historical information for the entity and wherein using the historical information eliminates a need to store multiple transactional data values.

3. The method of claim 1, wherein the entity is a customer.

4. The method of claim 1, wherein the entity is at least one component of a computer system.

5. The method of claim 4, wherein the transactional data value reflects an event of the computer system.

6. The method of claim 1, further comprising sending, based on a positive determination of the behavior change for the entity, a communication to the entity.

7. The method of claim 6, wherein the communication is selected from the group consisting of a survey, a discount notification, and a thank you letter.

8. The method of claim 6, wherein the communication comprises a computer system event.

9. The method of claim 1, wherein the current time period is selected from the group consisting of a second, a minute, an hour, a day, a week, a month, and six months.

10. The method of claim 1, wherein the step of computing the running mean value further comprises:
providing a previous running mean value;
multiplying the previous running mean value by a percentage weighting factor to get a weighted previous running mean;
multiplying the transactional data value by a second percentage weighting factor to get a weighted transactional data value, wherein the second percentage weighting factor is one minus the percentage weighting factor; and
adding the weighted previous running mean and the weighted transactional data value to get the running mean value.

11. The method of claim 1, wherein the step of computing the running mean square value further comprises:
providing a previous running mean square value;
multiplying the previous running mean square value by a percentage weighting factor to get a weighted previous running mean square;
multiplying a square of the transactional data value by a second percentage weighting factor to get a weighted transactional square value, wherein the second percentage weighting factor is one minus the percentage weighting factor; and
adding the weighted previous running mean square and the weighted transactional square value to get the running mean square value.

12. The method of claim 1, wherein the step of computing the running standard deviation further comprises:
subtracting a square of the running mean from the running mean square value to get a difference; and
taking the square root of the difference to get the running standard deviation.

13. The method of claim 1, wherein the determining step comprises:
computing a difference between the transactional data value and the running mean value;
dividing the difference by the running standard deviation to get a variance value; and
comparing the variance value with a threshold.

14. The method of claim 1, further comprising validating, based on a determination that the transaction data constitutes a behavior change for the entity, the validation step comprising:
providing a second transactional data value based on a second number of transactions of the entity over a second current time period;
computing, using the second transactional data value, a second running mean value; and
determining, using the running standard deviation, whether the second transactional data value also constitutes a behavior change for the entity.

15. A system for accumulating and analyzing transactional data to detect a behavior change, comprising:
a transaction data value provider for providing a transactional data value based on a measurement of transactions of an entity over a current time period;
a running mean value computer for computing, using the transactional data value, a running mean value;
a running mean square value computer for computing, using the running mean value, a running mean square value;
a running standard deviation computer for computing, using the running mean square value, a running standard deviation; and
a behavior change determinator for determining, using the running standard deviation, whether the transactional data value constitutes a behavior change for the entity,
wherein the system is adapted to function without a need to store multiple transactional data values.

16. The system of claim 15, further comprising a communication sender for sending, based on a positive determination of the behavior change for the entity, a communication to the entity.

17. The system of claim 16, wherein the communication is selected from the group consisting of a survey, a discount notification, and a thank you letter.

18. The system of claim 15, wherein the time period is selected from the group consisting of a day, a week, a month, and six months.

19. The system of claim 15, wherein the running mean value computer further comprises:
a running mean value provider for providing a previous running mean value;
a multiplier for multiplying the previous running mean value by a percentage weighting factor to get a weighted previous running mean and for multiplying the transactional data value by a second percentage weighting factor to get a weighted transactional data value, wherein the second percentage weighting factor is one minus the percentage weighting factor; and
an adder for adding the weighted previous running mean and the weighted transactional data value to get the running mean value.

20. The system of claim 15, wherein the running mean square value computer further comprises:
a running mean square value provider for providing a previous running mean square value;
a multiplier for multiplying the previous running mean square value by a percentage weighting factor to get a weighted previous running mean square and for multiplying a square of the transactional data value by a second percentage weighting factor to get a weighted transactional square value, wherein the second percentage weighting factor is one minus the percentage weighting factor; and
an adder for adding the weighted previous running mean square and the weighted transactional square value to get the running mean square value.

21. The system of claim 15, wherein the running standard deviation computer further comprises:
a subtractor for subtracting a square of the running mean from the running mean square value to get a difference; and
a square root taker for taking a square root of the difference to get the running standard deviation.

22. The system of claim 15, wherein the behavior change determinator comprises:
a difference computer for computing a difference between the transactional data value and the running mean value;
a divider for dividing the difference by the running standard deviation to get a variance value; and
a comparator for comparing the variance value with a threshold.

23. The system of claim 15, further comprising a change determination validator for validating, based on a determination that the transaction data constitutes a behavior change for the entity using a second transaction data value based on a second number of transaction of the entity over a second current time period.

24. A program product stored on a computer readable medium for accumulating and analyzing transactional data to detect a behavior change, comprising, the computer readable medium comprising program code for causing a computer system to perform the following steps:
provide a transactional data value based on a measurement of transactions of an entity over a current time period;
compute, using the transactional data value, a running mean value;
compute, using the running mean value, a running mean square value;
compute, using the running mean square value, a running standard deviation; and
determine, using the running standard deviation, whether the transactional data value constitutes a behavior change for the entity,
wherein the program product is adapted to function without a need to store multiple transactional data values.
